(19) United States
(12) Patent Application Publication
(10) Pub. No.: US 2025/0134080 A1
(43) Pub. Date: May 1, 2025

(54) ELECTROMAGNETIC BRAKE STRUCTURE FOR A FISHING REEL

(71) Applicant: Weihai Langbao Fishing Tackle Co.,Ltd, Weihai (CN)

(72) Inventor: WEI WANG, Weihai (CN)

(21) Appl. No.: 18/386,202

(22) Filed: Nov. 1, 2023

(51) Int. Cl. A01K 89/033; A01K 89/015

(52) U.S. Cl. CPC A01K 89/033; A01K 89/01931

(57) ABSTRACT

The invention discloses an electromagnetic brake structure of a fishing reel. The control box is equipped with a motherboard, electromagnet, inductive circuit board, battery, and other components. According to the rotation of the magnet on the side of the spool, the inductive circuit board transmits the generated real-time signal to the MCU on the motherboard. The MCU calculates through the program and controls the MOS to release different currents. After the electromagnet is energized, different electromagnetic fields are generated to realize the real-time adjustment of the braking force. There is a regulating switch outside the control box, which has several gears. The Bluetooth assembly is installed in the control box. The battery supplies power to both rechargeable and removable batteries.

### TECHNICAL FIELD

The present invention relates to a fishing reel, in particular to an electromagnetic brake structure for a fishing reel.

### BACKGROUND ART

In order to prevent the fishing line from getting entangled during the casting of ordinary baitcasting reels, multiple magnets are used on the side of the spool, which are assembled in a circular arrangement of alternate N and S poles to generate a series of magnetic fields. During the casting of the fishing reel, the bait drives the spool to rotate. At this time, the magnetic induction line cut by the spool will generate resistance in the opposite rotation direction of the spool, slowing down the rotation speed of the spool and preventing the fishing line from getting entangled.

The magnetic brake structure in prior art increases or decreases the magnetic field by regulating the distance between the magnetic field and the spool, adjusting the braking force of the magnet, ensuring that the braking force of the magnet matches the speed of the spool, and preventing the fishing line from getting entangled. The magnetic brake structure in prior art can only set a fixed braking force, and cannot achieve real-time regulation of braking force based on the speed of the spool. Moreover, the braking force needs to be regulated based on the weight of the bait, the user's casting technology, and the fishing environment, which greatly depends on the user's experience and technology. If the braking force is set relatively low, the fishing line is easy to get entangled during use; if the braking force is set too high, the bait is easily thrown closer, which undoubtedly increases the difficulty of using the baitcasting reels.

### SUMMARY

Regarding the above-mentioned prior art, the purpose of the present invention is to solve the problems of cumbersome regulation and difficult operation and use of magnetic brake for baitcasting reels, and to achieve real-time regulation of braking force, making it easier and simpler for users to use the baitcasting reels.

The purpose of the present invention is achieved through the following technical solutions:

An electromagnetic brake structure for a fishing reel, including a control box, a battery, a motherboard, an inductive circuit board, an electromagnet, and a spool.

The said battery, motherboard, inductive circuit board, and electromagnet are all installed in the control box.

The said motherboard is equipped with necessary accessories such as a processor chip, memory, and current control chip, etc.

The said memory is used to store the logs, control programs, casting data, braking force data, and user-defined data of the processor chip.

The said motherboard is electrically connected to the battery, which is used to power the motherboard and other components. The said battery is a rechargeable battery, e.g., lithium battery. The said rechargeable battery can be charged using the Type-C interface.

In addition to rechargeable battery, a removable battery can also be provided. The removable battery can be button battery, rechargeable battery, or dry battery. The priority should be given to using the lithium battery when it is fully charged; a removable battery can be used for power supply when the lithium battery is out of charge or unavailable. The easy replacement of the removable battery can greatly improve the endurance of the fishing reel.

The said current control chip is electrically connected to the said electromagnet. The number of the said electromagnets varies depending on the model of the fishing reel, which can be an even number of 2, 4, etc.

The said electromagnet (or electromagnet set) is installed in the control box opposite to the side of the said spool. The “opposite” here generally refers to the opposite of the right side, that is, after the electromagnet is energized and generates an electromagnetic field, the side of the spool is perpendicular to the direction of the electromagnetic field. However, on specific models, the vertical line on the side of the spool can be at a certain angle to the direction of the brake magnetic field.

A magnet set is installed on the side of the said spool, which rotates around the spool shaft; the magnet set rotates with the spool.

There is an inductive circuit board in the control box corresponding to the said magnet set, and this corresponding position allows the inductive circuit board to sense the rotation speed of the magnet set. It can be facing the side of the spool or at a certain angle to the side of the spool.

The inductive circuit board transmits the obtained magnetic induction signal to the said processor chip.

The processor chip makes the calculation through the control program and sends a signal to the current control chip to release the current, and the electromagnet generates an electromagnetic field when energized.

The said spool rotates in an electromagnetic field, cuts the magnetic induction lines, and generates electromagnetic braking force.

During casting, due to changes in the rotation speed of the spool, the rotation speed of the magnet set changes accordingly. Based on the magnetic induction signal generated by the inductive circuit board, the said processor chip makes the calculation through control program, and regulates the strength of the electromagnetic field by controlling the magnitude of the discharge current to achieve real-time regulation of the electromagnetic braking force.

As an improvement of the electromagnetic brake structure for a fishing reel in the present invention, there is a regulating switch outside the control box, which has several gears including the switch gear. For example, it can be set to four gears: OFF, L, M, and W. OFF gear is a switch gear used to turn off the power supply; L, M, and W gears are the bait weight selection gears, and different gears represent different bait weights. The processor chip can preset the current passing through the electromagnet by regulating the switch gear, regulating the strength of the electromagnetic field.

As an improvement of the electromagnetic brake structure for a fishing reel in the present invention, the Bluetooth assembly is installed in the said control box, through which the motherboard can communicate with external devices. Such external devices can be a mobile phone, computer, etc. Through software on external devices such as mobile phone, etc., users can receive the casting and braking force data saved by the fishing reel, and set the strength of the electromagnetic field and other data of the fishing reel as custom parameters based on the obtained data. In addition, users can also save the most suitable parameters on their mobile phones, and transmit the data directly to the fishing reel through Bluetooth when using the same type of bait weight again.

As another improvement of the electromagnetic brake structure for a fishing reel in the present invention, there is also an external software program, which can calculate the current curve released to the electromagnet based on the set value, custom data received by the Bluetooth assembly, or the rotation of the magnet set, and adjust the magnitude of the discharge current according to the discharge current curve, in order to achieve the real-time adjustment of the electromagnetic field. Users can also customize and adjust the discharge current curve according to their habits.

As another improvement of the electromagnetic brake structure for a fishing reel in the present invention, there is an alarm device in the said control box, including a clutch button, an induction magnet, and a buzzer. The said clutch button is located on the outer side of the control box, and a magnet seat is provided on the said clutch button, which is equipped with an induction magnet; there is a magnetic sensor in the said control box, which is connected to the said motherboard. During casting, the induction magnet can undergo magnetic induction with the magnetic sensor after the clutch button is pressed. At this time, the fishing line drags the spool to rotate, and the buzzer will not sound an alarm. After collecting the line and resetting the clutch button, the induction magnet will not undergo magnetic induction with the magnetic sensor. At this time, the fishing line drags the spool to cast the line, and the buzzer will sound a “beep” alarm to remind the user that the dragging force of the fishing line is greater than the predetermined release force of the fishing reel.

As another improvement of the electromagnetic brake structure for a fishing reel in the present invention, there is an alarm device (buzzer) in the said control box; After casting, the spool will stop rotating and the buzzer will emit a “beep” alarm sound to remind the user that the casting is completed.

As another improvement of the electromagnetic brake structure for a fishing reel in the present invention, the control box is equipped with a sealing ring and a control box cover. The control box cover is installed on the control box and secured with four screws A. After tightening, the control box and the control box cover jointly squeeze the sealing ring to seal the circuit board inside the control box, playing a waterproof role.

The present invention effectively solves the problems of cumbersome regulation and difficult operation and use of magnetic brake for the fishing reel in the prior art. An electromagnetic brake structure for a fishing reel is provided that facilitates users to regulate the braking force, to customize braking force parameters, and to adjust the braking force in real time.

### BRIEF DESCRIPTION OF THE DRAWINGS

FIG. 1 illustrates the assembly diagram of embodiment 1 of the electromagnetic brake structure for a fishing reel in the present invention;

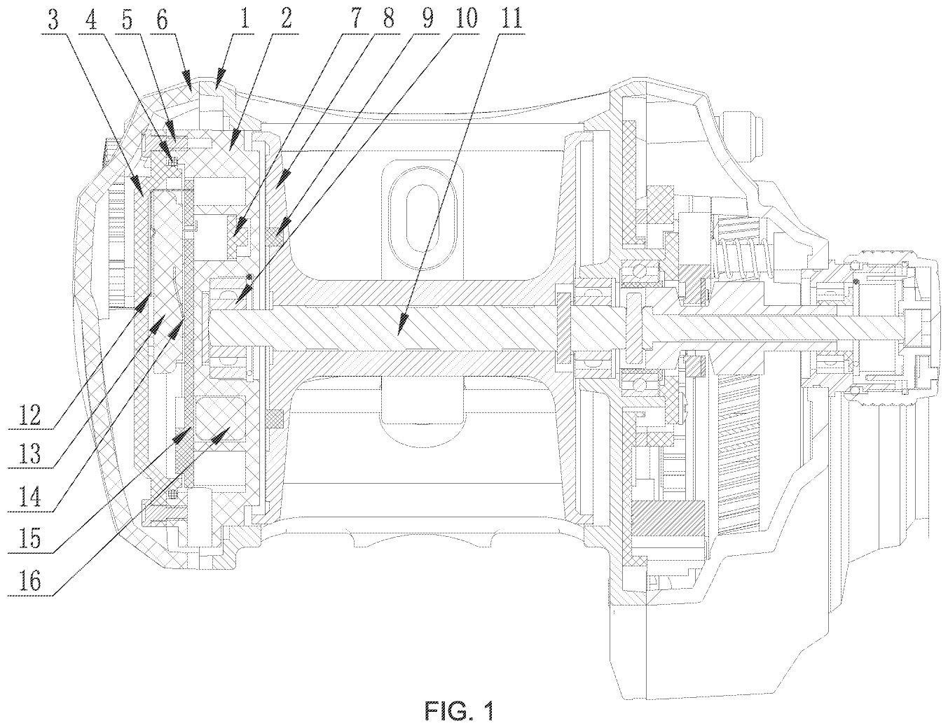

FIG. 2 illustrates the assembly diagram of the control box in embodiment 1 of the electromagnetic brake structure for a fishing reel in the present invention;

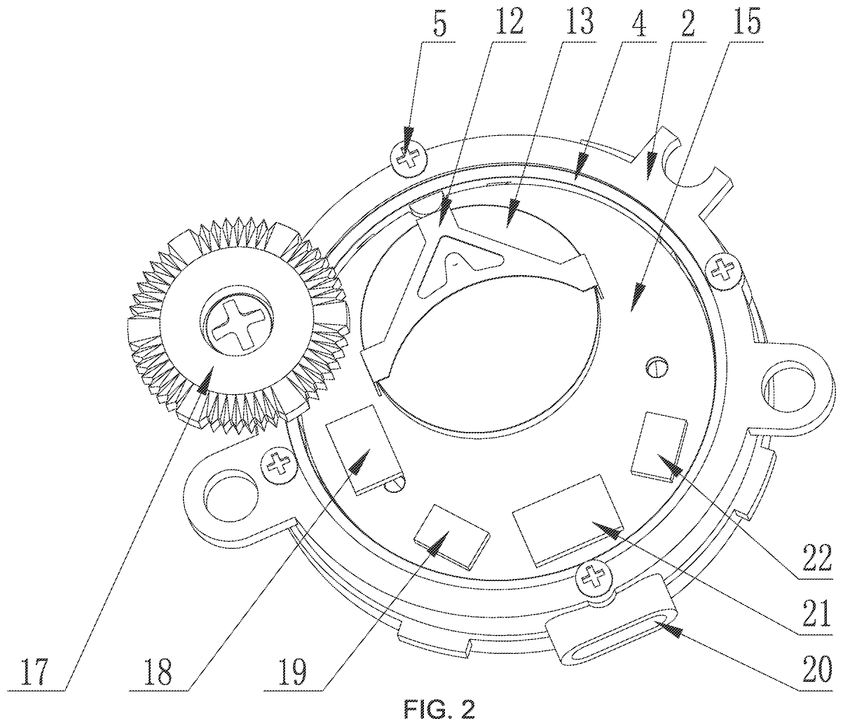

FIG. 3 illustrates the reverse assembly diagram of the motherboard in embodiment 1 of the electromagnetic brake structure for a fishing reel in the present invention;

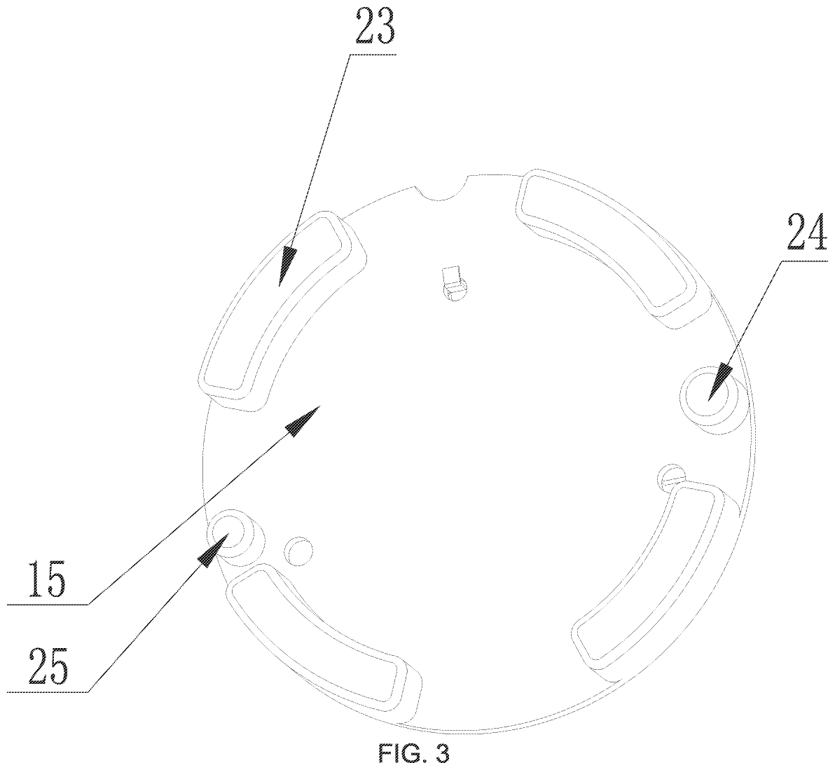

FIG. 4 illustrates the assembly diagram of the B cover in embodiment 1 of the electromagnetic brake structure for a fishing reel in the present invention;

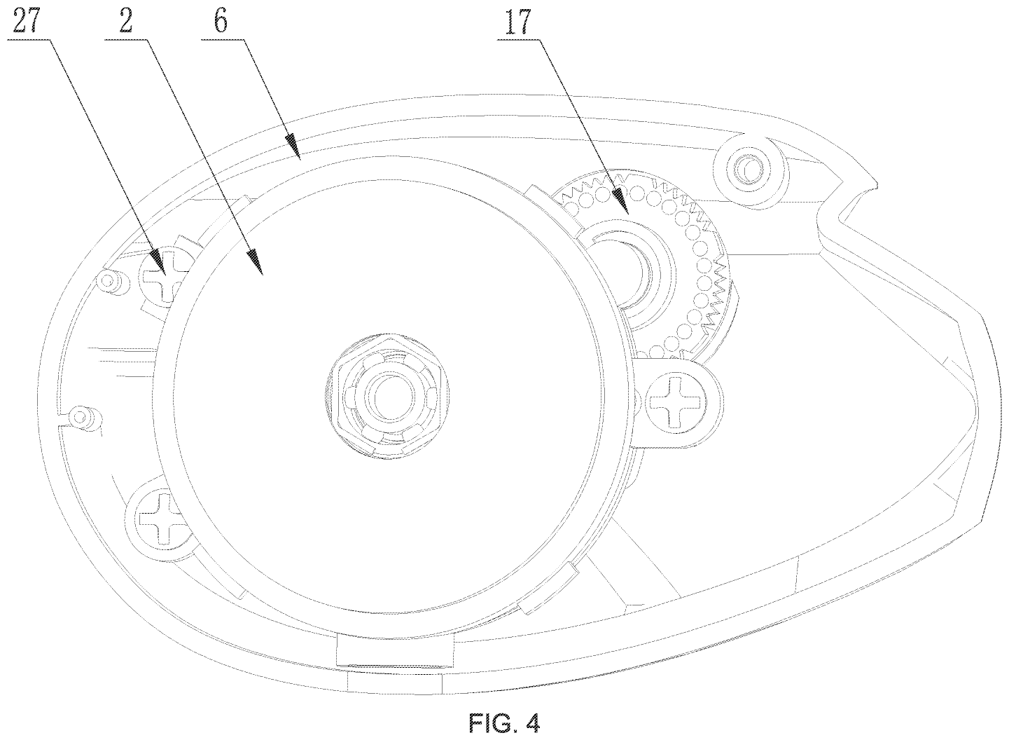

FIG. 5 illustrates a schematic diagram of the alarm device in embodiment 1 of the electromagnetic brake structure for a fishing reel in the present invention when the clutch button is pressed;

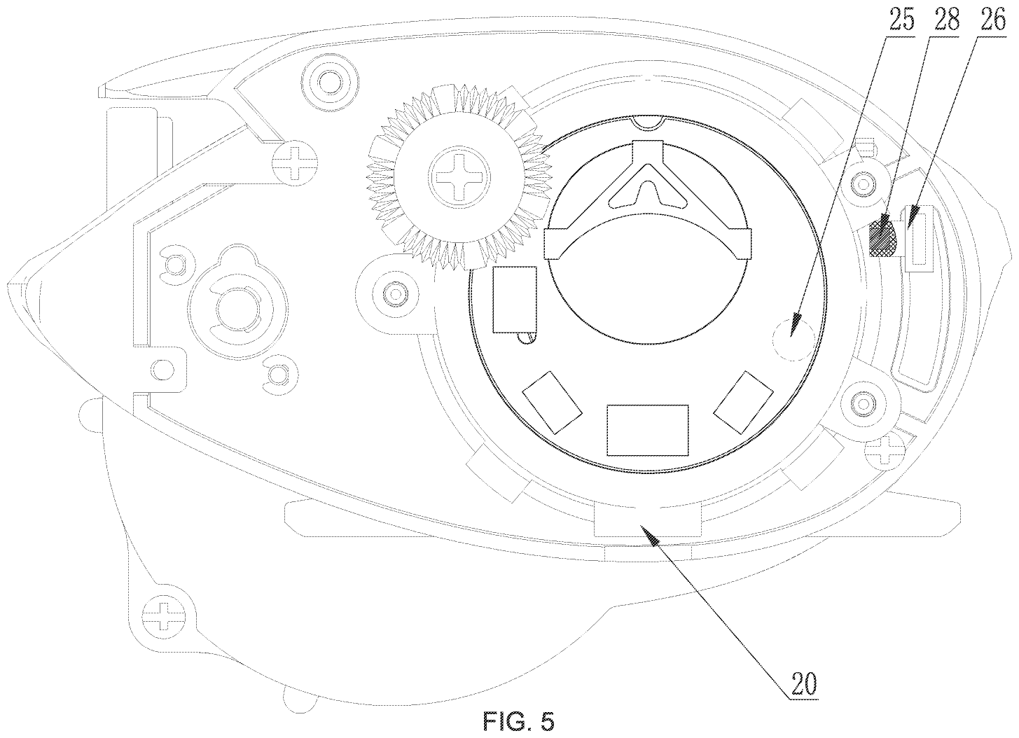

FIG. 6 illustrates a schematic diagram of the alarm device in embodiment 1 of the electromagnetic brake structure for a fishing reel in the present invention when the clutch button is reset;

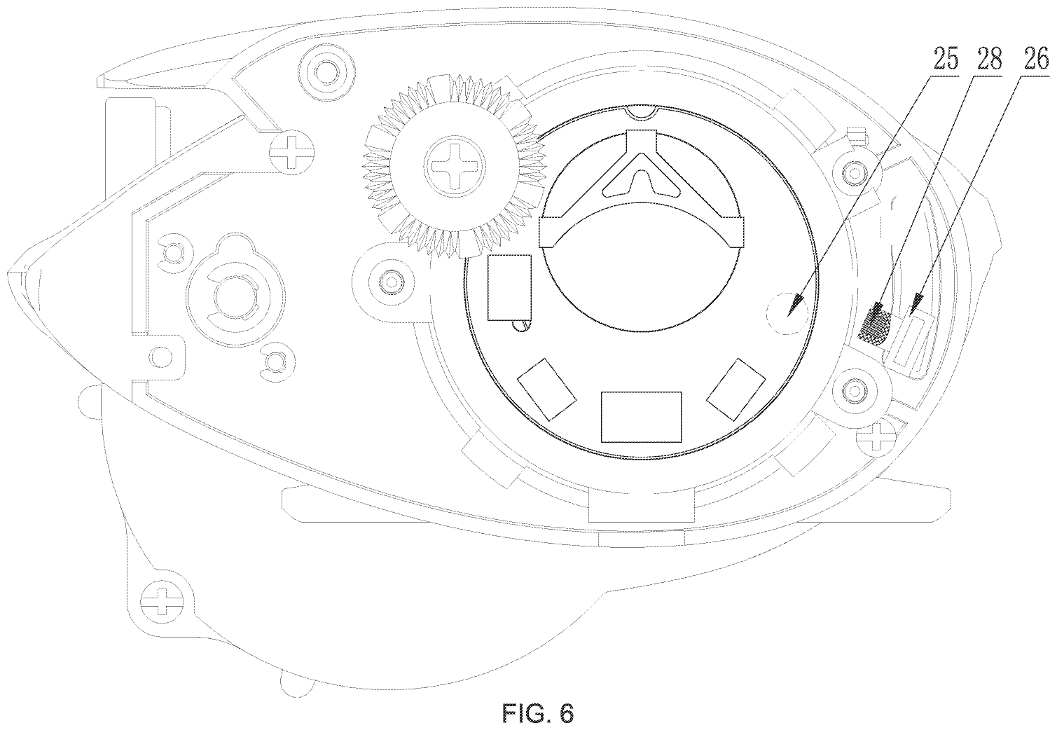

FIG. 7 illustrates a schematic diagram of the position of the inductive circuit board and lithium battery in embodiment 1 of the electromagnetic brake structure for a fishing reel in the present invention;

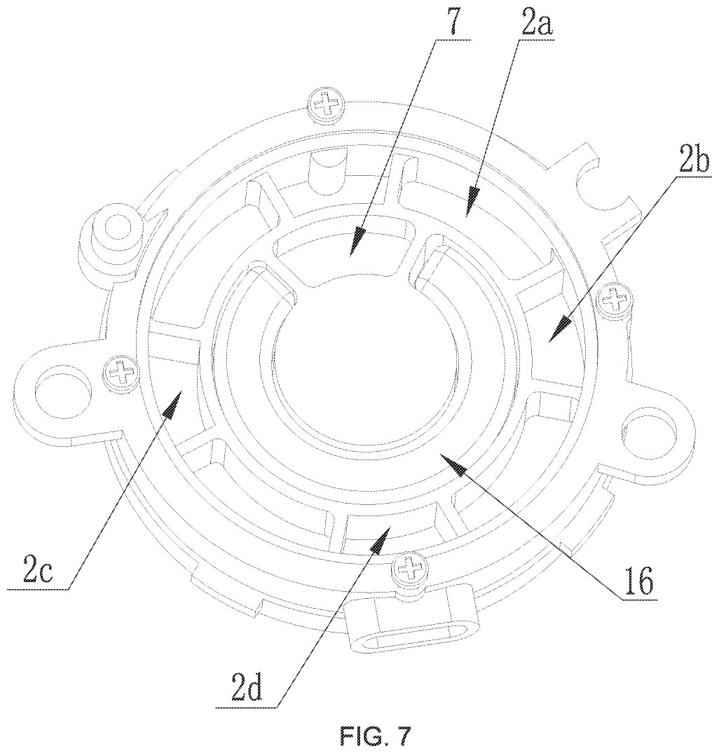

FIG. 8 illustrates a schematic diagram of the position of the spool and magnet in embodiment 1 of the electromagnetic brake structure for a fishing reel in the present invention.

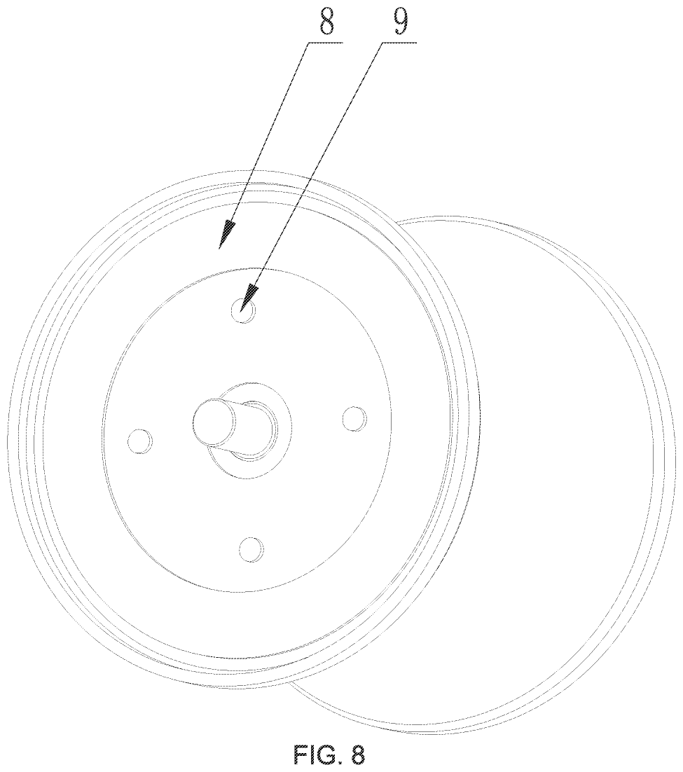

Wherein: 1—support, 2—control box, 2a—electromagnet hole, 2b—sensor hole, 2c—buzzer hole, 2d—Type-C interface hole, 3—control box cover, 4—sealing ring, 5—screw A, 6—B cover, 7—inductive circuit board, 8—spool, 9—magnet, 10—bearing, 11—spool shaft, 12—shrapnel A, 13—button battery, 14—shrapnel B, 15—motherboard, 16—lithium battery, 17—regulating switch, 18—current control chip, 19—memory, 20—Type-C interface, 21—processor chip, 22—Bluetooth assembly, 23—electromagnet, 24—buzzer, 25—magnetic sensor, 26—magnet seat, 27—screw B, 28—induction magnet.

### DETAILED DESCRIPTION

### Embodiment 1

An electromagnetic brake structure for a fishing reel, including a control box 2, a battery 16, a motherboard 15, an inductive circuit board 7, an electromagnet 23, and a spool 8.

There is a control box 2 on the B cover 6 of the fishing reel, which contains a battery 16, a motherboard 15, and an inductive circuit board 7.

The motherboard 15 is electrically connected to battery 16, which is used to power the motherboard 15 and other components. The battery 16 is a rechargeable lithium battery. In addition to lithium battery, a button battery 13 is also provided. The button battery 13 is connected to the motherboard 15 through shrapnel A12 and shrapnel B14. The button battery 13 can be quickly replaced, improving the usability of the fishing reel. Both battery 16 and button battery 13 can supply power to the motherboard 15. The priority should be given to using battery 16 for power supply when battery 16 is fully charged; the button battery 13 shall be used for power supply when lithium battery 16 is out of charge or unavailable. The easy replacement of the button battery 13 can greatly improve the endurance of the fishing reel.

The motherboard 15 is installed on the opposite side of the spool. The motherboard 15 is a double-sided motherboard, with current control chip 18, processor chip 21, memory 19, Bluetooth assembly 22 and other chips installed on the right side, and electromagnet 23, buzzer 24, magnetic sensor 25, and Type-C interface installed on the reverse side, which are respectively installed in electromagnet hole 2a, buzzer hole 2c, sensor hole 2b, and Type-C interface hole 2d of control box 2. The reverse side of motherboard 15 is facing the side of the spool. The current control chip 18 is electrically connected to the electromagnet 23. The number of electromagnets is 4. The right side and the reverse side of the motherboard are just a name, and do not mean that the motherboard distinguishes the right side or the reverse side from its structure.

A magnet set 9 is installed on the side of the spool 8 near the motherboard. The control box 2 opposite the magnet set 9 is fixed with an inductive circuit board 7, which is fixed inside the control box 2 and connected to the motherboard 15 through a wire. At this time, the sides of inductive circuit board 7, electromagnet 23 and spool 8 are roughly parallel to the planes of magnet set 9.

There is a sealing ring 4 inside the control box 2, and the control box cover 3 is installed on control box 2 and fixed with four screws A 5. The control box cover 3 and the sealing ring 4 are squeezed to seal the control box.

The inductive circuit board 7 transmits the obtained magnetic induction signal to the supporting processor chip 21, which calculates the magnitude of current to be released to electromagnet 23 through the control program based on the obtained magnetic induction signal, user settings, and other data, and sends a signal to release the current to the current control chip 18, and electromagnet 23 generates an electromagnetic field when energized. The spool 8 rotates in an electromagnetic field, cuts the magnetic induction lines, and generates magnetic brake.

The Bluetooth assembly 22 is installed in the control box 2, through which the motherboard 15 can communicate with external devices, such as mobile phones, etc. Through software on the mobile phone, etc., users can receive the casting and electromagnetic field data saved by the fishing reel, and set the electromagnetic field and other data of the fishing reel as custom parameters based on the obtained data. In addition, users can also save the most suitable parameters on their mobile phones, and transmit the data directly to the fishing reel through Bluetooth when using the same type of bait weight again.

The control program can calculate and form the discharge current curve released to electromagnet 23 based on the signal obtained from inductive circuit board 7, custom data received by Bluetooth assembly 22, or the rotation signal of magnet set 9. According to the discharge current curve, the discharge current of current control chip 18 can be adjusted to achieve the real-time regulation of the strength of the electromagnetic field. External software programs can also be used to adjust or customize the strength of the electromagnetic field in real time based on user preset programs, data, models, etc.

There is a regulating switch 17 outside the control box 2, which has four gears of OFF, L, M, and W. OFF gear is a switch gear used to turn on/off the power supply; L, M, and W gears are the bait weight selection gears, and different gears represent different bait weights. The processor chip 21 can preset the current passing through the electromagnet by regulating the gear of switch 17 to regulate the size of the electromagnetic braking force promptly.

The clutch button is located on the outer side of the control box 2, which is equipped with a magnet seat 26 and an induction magnet 28 inside the magnet seat 26; there is a magnetic sensor 25 in the control box 2, which is connected to the motherboard 15. During casting, the induction magnet 28 can undergo magnetic induction with the magnetic sensor 25 after the clutch button is pressed. At this time, the fishing line drags the spool 8 to rotate, and the buzzer 24 will not sound an alarm. After collecting the line and resetting the clutch button, the induction magnet 28 will not undergo magnetic induction with the magnetic sensor 25. At this time, the fishing line drags the spool 8 to cast the line, and the buzzer 24 will sound a “beep” alarm to remind the user that the dragging force of the fishing line is greater than the predetermined release force of the fishing reel.

There is an alarm device (buzzer 24) in the said control box 2; after casting, the spool 8 will stop rotating and the buzzer 24 will emit a “beep” alarm sound to remind the user that the casting is completed.

The control box 2 is equipped with sealing ring 4 and control box cover 3. The control box cover 3 is installed on the control box 2 and secured with four screws A 5. After tightening, the control box 2 and the control box cover 3 jointly squeeze the sealing ring 4 to seal it.

The above contents disclosed are merely the specific embodiments of the present invention. However, the present invention is not limited as the above contents. Any changes that can be taken into account by the persons skilled in the art shall be included in the protection scope of the present invention.

What is claimed is:

1. An electromagnetic brake structure for a fishing reel, including a control box, a battery, a motherboard, an inductive circuit board, an electromagnet, and a spool, wherein:
The said motherboard is equipped with a processor chip, a current control chip, and a memory. The said motherboard is electrically connected to the said battery, and the said current control chip is electrically connected to the said electromagnet; The said memory is used for storing data and control programs, etc.;
A magnet set is installed on the side of the said spool, which rotates around the spool shaft; The said electromagnet is installed in the control box opposite the side of the said spool;
There is an inductive circuit board in the control box corresponding to the said magnet set, which senses the rotation of the magnet set and transmits the generated magnetic induction signal to the said processor chip;
Based on the obtained signal, the said processor chip makes the calculation through the control program and sends a corresponding signal to the current control chip to release the current, and the electromagnet generates an electromagnetic field when energized;
The said spool rotates in an electromagnetic field, cuts the magnetic induction lines, and generates electromagnetic braking force. Under the same speed of the spool, the strength of the electromagnetic field determines the magnitude of the electromagnetic braking force generated.

2. The electromagnetic brake structure for a fishing reel according to claim 1, wherein: there is a regulating switch outside the control box, which has several gears including the switch gear. The processor chip can regulate the magnitude of current of the electromagnet by regulating the switch gear, regulating the strength of the electromagnetic field.

3. The electromagnetic brake structure for a fishing reel according to claim 1, wherein: the Bluetooth assembly is installed in the said control box, through which the motherboard can communicate with external devices, and the said Bluetooth assembly can receive and send parameters related to the fishing reel.

4. The electromagnetic brake structure for a fishing reel according to claim 3, wherein: there is also an external software program, which can calculate the current curve released to the electromagnet based on the set value, custom data received by the Bluetooth assembly, or the rotation of the magnet set, and adjust the strength of the electromagnetic field in real time.

5. The electromagnetic brake structure for a fishing reel according to claim 1, wherein: there is an alarm device in the said control box, including a clutch button, an induction magnet, and a buzzer;
The said clutch button is located on the outer side of the said control box, and a magnet seat is provided on the said clutch button, which is equipped with an induction magnet;
There is a magnetic sensor in the said control box, which is connected to the said motherboard;
After pressing the clutch button, the induction magnet can undergo magnetic induction with the magnetic sensor; After resetting the clutch button, the induction magnet will not undergo magnetic induction with the magnetic sensor. At this time, the fishing reel casts the line, and the buzzer will sound an alarm.

6. The electromagnetic brake structure for a fishing reel according to claim 1, wherein: the clutch button can be pressed to cast the line. After casting, the spool will stop rotating and the buzzer will emit a “beep” alarm sound to remind the user that the casting is completed.

7. The electromagnetic brake structure for a fishing reel according to claim 1, wherein: the said battery is a rechargeable battery;
a removable battery can also be provided, which can be used for power supply when the rechargeable battery is out of charge or unavailable.

8. The electromagnetic brake structure for a fishing reel according to claim 7, wherein: the said rechargeable battery is a lithium battery that can be charged using the Type-C interface.

9. The electromagnetic brake structure for a fishing reel according to claim 1, wherein: the said control box is equipped with a sealing ring and a control box cover, and the control box and the control box cover jointly squeeze the sealing ring to prevent water from entering the control box.
